(19) United States
(12) Patent Application Publication
(10) Pub. No.: US 2019/0240988 A1
(43) Pub. Date: Aug. 8, 2019

(54) METHOD FOR OPERATING A PRINTING DEVICE AND PRINTING DEVICE

(71) Applicant: Merck Patent GmbH, Darmstadt (DE)

(72) Inventors: Leticia GARCIA DIEZ, Darmstadt (DE); Edgar BOEHM, Griesheim (DE); Volker HILARIUS, Gross-Umstadt (DE)

(21) Appl. No.: 16/343,450

(22) PCT Filed: Oct. 18, 2017
(86) PCT No.: PCT/EP2017/076553

§ 371 Date: Apr. 19, 2019

(30) Foreign Application Priority Data
Oct. 21, 2016 (DE) 10 2016 012574.8

(51) Int. Cl. B41J 2/20; B41J 2/175

(52) U.S. Cl. CPC B41J 2/20; B41J 2/17563

(57) ABSTRACT

In the case of a method for operating a printing device (1), wherein a fluid that is provided for a printing procedure is supplied from a fluid storage container (6) by way of a supply line (14) to a printing head (13) so as to be able to be applied by the printing head (13) onto a surface, the fluid in a purification circuit (2) is conveyed through a purification installation (8), and by way of a contamination-measurement installation (11) a key contamination indicator of a fluid-specimen quantity in the purification circuit (2) is determined such that a printing procedure by way of which the fluid is dispensed from the printing head (13) commences only once the key contamination indicator has undershot a first threshold value. The invention also relates to a printing device (1) having a printing head (13) and having a connector installation (12) for a fluid storage container (6), said connector installation (12) being connected to the printing head (13) by way of a supply line (14), wherein the printing device (1) has a purification circuit (2) that is formed from fluid-line portions (3, 4, 5) and has a purification installation (8) and has a contamination-measurement installation (11) in which the fluid that by way of the fluid retrieval installation has been retrieved form the fluid storage container (6) can be purified, and a key contamination indicator of a fluid-specimen quantity in the purification circuit (6) can be determined before the purified fluid is supplied to the printing head (13).

The present invention relates to a method for operating a printing device, wherein a fluid that is provided for a printing procedure is supplied from a fluid storage container by way of a supply line to a printing head so as to be able to be applied by the printing head onto a surface.

Various organic semiconductor materials which, for example, are suitable for the manufacturing of organic semiconductor components, and in particular for the manufacturing of organic light-emitting diodes and respective displays, have been developed in recent years. Various printing technologies by way of which the organic semiconductor materials that have been dissolved in a suitable solvent can be applied to a predefined surface are suitable inter alia for the processing of the organic semiconductor materials. In this manner, large-area displays, for example, which are assembled from a very large number of organic light-emitting diodes (OLEDs) composed of organic semiconductor materials that are actuatable in a mutually independent manner can be printed using ink-jet printing devices that are known in practice.

The printing technologies presently known enable rapid manufacturing of parts, and in particular of displays from organic semiconductor materials, that is simple in terms of the method sequence. It has been demonstrated, however, that almost unavoidable contamination of the dissolved organic semiconductor materials with particles and dissolved gases is of particular significance for the product quality of the parts and of the displays. Despite great efforts in the manufacturing and the filling of organic semiconductor materials, contamination by foreign particles is difficult to avoid. Moreover, the organic semiconductor materials that are dissolved in the solvent are highly sensitive to the ambient air and also to moisture such that the organic semiconductor materials already upon brief contact with the ambient air can absorb a product-threatening quantity of gases or moisture.

In order to achieve the purity required for further processing of the organic semiconductor materials, the semiconductor materials that are dissolved in a suitable organic solvent are usually purified, filtered, and de-gassed in a multi-stage purification process. The purified fluid from the dissolved organic semiconductor material is subsequently filled into a transportation container and moved from the manufacturing site of the organic semiconductor materials to a production site of the respective parts or displays, for the manufacturing of which the organic semiconductor material is required. Herein, the transportation containers are also purified prior to filling with organic semiconductor material, so as to minimize as far as possible the contamination of the fluid that is filled into and transported in the transportation containers. Furthermore, a significant effort is made also at the production site of the respective components and parts when the transportation container that has been transported there is connected to a printing device, or refilled into a fluid storage container of the printing device, and optionally also prior to starting-up and during the operation of the production device, so as to minimize as far as possible any contamination and pollution of the fluids that contain the organic semiconductor materials.

Since the material costs and the manufacturing effort for many organic semiconductor materials are very high, an attempt has to be made of using the organic semiconductor material as efficiently as possible in the manufacturing of the product, and of simultaneously minimizing as far as possible that proportion of the fluid that is not usable for the production of the components. For example, no excessive proportion of the fluid must be lost for the subsequent production by purification of the fluid. Moreover, dead volumes during the production and use of the fluid should be as small as possible so as to minimize as far as possible that proportion of the fluid that is not utilizable for the production of the components.

Since already the smallest quantities of contaminants and optionally individual particles of a contamination can render useless a product such as a large-size display, for example, that has been manufactured using the respective organic semiconductor material, very high requirements are often set for the manufacturing and transportation of the organic semiconductor material up to the production site of the respective components or displays, respectively. Therefore, measurements and checks of the quality of the dissolved organic semiconductor material in practice are carried out in the manner of random samples usually during and after the production of the dissolved organic semiconductor materials, so as to be able to verify and guarantee the predefined purity of the fluid. The effort associated therewith for the manufacturing and checking of the dissolved organic semiconductor material as well as for the transportation thereof up to the respective production facility of the respective products is complex and cost intensive.

It is therefore seen as an object of the present invention to design a method for operating a printing device with a fluid such that the fluid during a printing procedure has the minimum possible contamination and that the effort required to this end is as minor as possible.

This object according to the invention is achieved in that the fluid in a purification circuit of the printing device is conveyed through a purification installation, and by way of a contamination-measurement installation a key contamination indicator of a fluid-specimen quantity in the purification circuit is determined, and in that a printing procedure by way of which the fluid is dispensed from the printing head commences only once the key contamination indicator has undershot a first threshold value.

The fluid can be recirculated and purified multiple times in the purification circuit before the printing procedure commences. The fluid is conveyed through the purification installation and purified in the case of each purification cycle. The purification methods known in practice, such as filtering or de-gassing, for example, as a matter of principle and depending on the respective implementation have average or maximum purification efficiency, respectively, such that a respective proportion of contaminants can be separated and removed from the fluid during a purification step. By experience, adequate purity of the fluid can still not be achieved or guaranteed, respectively, in many cases following a one-time purification of the fluid in a purification installation which contains a filter installation or a de-gassing installation, for example. The purification installation can also have a plurality of filter installations and a plurality of de-gassing installations, for example. A plurality of filter installations or de-gassing installations can be disposed in a cascading manner and be designed so as to have increasing separation criteria, for example. Nevertheless, the purification effect in the case of a one-time perfusion of a purification installation that comprises a plurality of components is limited. By way of the integration of a contamination-measurement installation in the purification circuit in which the fluid is conveyed multiple times through the purification installation and, on account thereof, is continuously purified more intensely, the remaining contamination can be detected at any time by the contamination-measurement installation and be considered in terms of the further process sequence. The key contamination indicator herein can be established continuously, at regular or predefined temporal intervals, or else only on demand or upon an inquiry by a user. The key contamination indicator can be composed of a single contamination parameter or else be combined from a plurality of contamination parameters which each are detected and mutually correlated. The contamination parameters can comprise a particle count that is optionally differentiated according to the particle size, or a gas content, for example. The effort for establishing the key contamination indicator is usually very minor. The first threshold value can be predefined so as to depend on those contamination parameters that are considered relevant in the individual case, or can permit a variable weighting of individual contamination parameters.

By way of the method according to the invention, the contaminant content, or the purity, of the fluid that is supplied to the printing device, respectively, can be determined before an individual printing procedure commences. As compared to methods known in the prior art, in which dedicated fluid specimens are retrieved with an additional effort from individual and already filled transportation containers or fluid storage containers, these fluid specimens being examined for contaminants, before a printing procedure is started, by way of the method according to the invention, without any significant additional effort the content of each individual fluid storage container can be checked and the contaminant content of the fluid that is supplied to the printing head can be monitored before a printing procedure commences.

Should it be established prior to a printing procedure that the key contamination indicator, determined by the contamination-measurement installation of the fluid-specimen quantity that has been supplied to the contamination-measurement installation, has an undesirably high contamination, a proportion of the fluid that has already been retrieved from the fluid storage container, for example, following a purification cycle can be returned into the fluid storage container, in order for a more intensely purified fluid proportion to be subsequently retrieved from the fluid storage container and to be supplied to the printing head.

Based on experience, a contamination of a fluid that is provided for the printing procedure is unavoidable both during the production as well as during transportation and introduction into the printing device. In practice, it is therefore expedient for the fluid from the fluid storage container to first be subjected to a few purification cycles in the purification circuit of the printing device, before the commencement of a printing procedure is envisaged. The key contamination indicator herein by way of the contamination-measurement installation can be determined continuously, at temporal intervals, or so as to commence only upon a predefined number of purification cycles. The contamination-measurement installation herein can also include a plurality of separate measurement installations such as, for example, one or a plurality of particle counters, and a gas-content measurement apparatus, or a plurality of measurement apparatus for different gas contents. The printing procedure is subsequently commenced only once the key contamination indicator that has been measured by the contamination-measurement installation undershoots the first threshold value which is predefined such that the desired purity of the fluid that is retrieved from the fluid storage container can be achieved and guaranteed in an adequately reliable manner.

By carrying out the method according to the invention, the requirements set for the purity of the fluid during the production and during the transportation to the printing device can be significantly reduced since re-purification of the fluid takes place in the printing device until the purity desired for the respective printing procedure is achieved. On account thereof, the procurement of the fluid becomes significantly more cost-effective as compared with complex purification procedures during the production and prior to the transportation to the printing device if no further purification were to be subsequently performed.

The method according to the invention can advantageously be used for printing procedures using identical or dissimilar fluids, for which the purity of the fluid, or a contamination of the fluid that is as minor as possible, respectively, is relevant, and where different requirements in terms of purity are to be met in the case of different printing procedures. The purity desired for each printing procedure can be achieved and guaranteed by predefining threshold values in a suitable manner. One important field of application of the method according to the invention relates to organic semiconductor materials which are filled as a solution or as a component part of a liquid ink material, respectively, into a fluid storage container, in order to be able to be used in the production of an organic semiconductor component. The respective fluids can also be filled into a transportation container during or immediately following production, in order to be retrieved from the transportation container and be refilled into a fluid storage container at the site of the intended use. It is also conceivable for the transportation container to be used as a fluid storage container.

The organic semiconductor material herein can be used for producing OLEDs and in particular OLED displays, for example. However, other fluids which contain functional components or dissolved component parts, for example, for the function or effect of which, after the application thereof, it is necessary for the fluid as far as possible not to exceed predefined threshold values pertaining to a maximum permissible contamination can also be advantageously used for printing surfaces by the method according to the invention.

According to one design embodiment of the concept of the invention, it is provided that the fluid-specimen quantity that is provided for determining the key contamination indicator is diverted from the purification circuit, is supplied to the contamination-measurement installation, and upon determining the key contamination indicator is again returned into the purification circuit, in order for the circulation of the fluid in the purification circuit not to be limited by a dwell time of the fluid in the contamination-measurement installation that would be required for carrying out a measurement. On account thereof, the fluid in the purification circuit can circulate at a high throughflow rate which is optionally limited by a maximum perfuse rate that is predefined by the purification installation. The fluid-specimen quantity that is diverted from the purification circuit and is supplied to the contamination-measurement installation can dwell in the latter independently of the perfuse rate that is predefined in the purification circuit, so as to enable measurements of adequate precision and accuracy. It is assumed herein that the fluid circulating in the purification circuit is adequately mixed and homogeneous, such that the key contamination indicator that is determined by the fluid-specimen quantity is characteristic of the contamination of the fluid circulating in the purification circuit.

According to one particularly advantageous design embodiment of the concept of the invention, it is provided that the printing head has a return line into the purification circuit, and that a printing head cleaning fluid quantity that is conveyed into the printing head is again retrieved from the printing head and is returned into the purification circuit. It has been demonstrated that the contamination of the fluid during a printing procedure is not caused exclusively by an unavoidable contamination of the fluid during the manufacturing of the fluid, but that a contamination of the initially not yet used printing head can also contribute a noticeable proportion towards the contamination of the fluid. The printing head can be contaminated during prolonged downtimes or on account of a preceding printing procedure. Dedicated cleaning of the printing head is complex and cost intensive. For this reason, the printing head can be incorporated into the purification circuit and be perfused by the fluid such that contaminants in the printing head are absorbed by the fluid and can be filtered therefrom into the purification circuit during a subsequent perfusion of the purification installation.

Particularly reliable monitoring and predefining of the purity of the fluid which is provided for the printing procedure can be achieved in that a key contamination indicator of that printing head cleaning fluid quantity that has been returned from the printing head is determined by the contamination-measurement installation, and in that the printing procedure by way of the printing head commences only once the key contamination indicator undershoots a second threshold value. It can be ensured in this way that not only the fluid that has been retrieved from the fluid storage device, but also the fluid that perfuses the printing head, has a predefined purity such that no additional excessive contamination can be generated by the printing head during a printing procedure. On account thereof, not only the degree of contamination or the degree of purity, respectively, of the fluid after retrieval from the fluid storage container, but also the degree of purity of the fluid that has already perfused the printing head, can be detected or monitored, respectively, and on account thereof also be predefined, by way of the contamination-measurement installation integrated in the purification circuit. The degree of purity that is established after perfusion of the printing head most typically also corresponds to the degree of purity encountered by a user of the fluid in the printing of electronic parts or displays, as long as no subsequent contamination of the fluid arises during the renewed perfusion of the purification circuit, of the supply line, and of the printing head. This can be prevented to the largest extent by way of a suitable design embodiment of the printing device. The second threshold value can be predefined so as to be higher than the first threshold value, since any potential uncertainties pertaining to a subsequent contamination have already been significantly reduced.

According to experience, since a contamination of the fluid by the supply line and by the printing head is less than any unavoidable contamination of the fluid that has arisen during the production of the fluid up to the filling of the latter into the fluid storage container of the printing device per se, it is provided according to the invention that the fluid first passes through a few purification cycles in the purification circuit and is then supplied to the printing head only once a key contamination indicator that is determined in the fluid-purification step of the fluid that is conveyed in the purification circuit undershoots a third threshold value. The fluid that is provided for a printing procedure can thus initially circulate in the purification circuit, until a key contamination indicator has dropped to a tenth or to a hundredth of the original value, for example. The printing head can subsequently be incorporated into the purification circuit and be perfused by the circulating fluid so as to evacuate the contaminants that are present in the printing head. The fluid herein continues to circulate in the purification circuit until the key contamination indicator has dropped further, for example to one percent or to one per mill of the original value, and an adequate purity of the fluid circulating in the purification circuit and through the printing head is confirmed.

According to one design embodiment of the concept of the invention it is provided that the fluid in the fluid-purification step is conveyed through at least one particle filter and through a de-gassing installation. A combination of a particle filter and of a de-gassing installation is expedient and advantageous in particular in the case of filling of organic semiconductor materials, the subsequent utilization of which can be compromised and restricted both by particle contaminants as well as by gaseous contaminants. It is likewise conceivable for a plurality of particle filters having congruent filter properties to be combined with one another, so as to increase the efficiency of the purification installation. A plurality of particle filters having dissimilar filter properties, or dissimilar filter classifications, respectively, can also be combined, and two or three particle filters which are able to filter increasingly small particle diameters can be sequentially disposed, for example. A combination of a plurality of de-gassing installations can also be expedient so as to filter dissimilar gases, for example, or so as to increase the efficiency of de-gassing in the case of a pass through the purification installation.

It is expediently provided according to the invention that the key contamination indicator is composed of a key particle-content indicator and of a key gas-content indicator, each being detected by the contamination-measurement installation. Contaminations by particles and by a gas content can thus be checked in a mutually independent manner and by way of suitable threshold values can be acquired and considered for the sequence and for controlling the method according to the invention. It is likewise possible for a plurality of key particle-content indicators to be simultaneously detected and to be considered for the method sequence, such that, for example, the respective particle content of the fluid to be filled is monitored for dissimilar ranges of particle diameters, and purification of the fluid is continued until the respectively predefined threshold values are undershot or else achieved or maintained, respectively, in all relevant ranges of the particle diameters.

The invention also relates to a printing device having a printing head and having a connector installation for a fluid storage container, said connector installation being connected to the printing head by way of a supply line such that the fluid from the fluid storage container can be supplied to the printing head and be applied by the printing head onto a surface. It is provided according to the invention that the connector installation has a fluid retrieval installation and a fluid refilling installation for the fluid storage container, that the printing device has a purification circuit that is formed from fluid-line portions and has a purification installation and has a contamination-measurement installation in which the fluid that by way of the fluid retrieval installation has been retrieved from the fluid storage container can be purified, a key contamination indicator of a fluid-specimen quantity in the purification circuit can be determined, and the fluid by way of the fluid refilling installation can again be supplied to the fluid storage container, and that the supply line branches off from the purification circuit and connects the purification circuit to the printing head such that the fluid that perfuses the purification circuit can be supplied to the printing head. The fluid that is provided for a subsequent printing procedure can be recirculated in a purification circuit in a simple manner and, on account thereof, guided through the purification installation that is disposed in the purification circuit multiple times by way of the printing device according to the invention. An already achieved purification effect can simultaneously be checked by the contamination-measurement installation. The printing procedure can be commenced after adequate upgrading of the fluid by purification in the purification circuit.

It is provided according to the invention that a return line connects the printing head to the purification circuit such that the fluid that is supplied to the printing head can perfuse the printing head and again be supplied to the purification circuit. In this way, the printing head can be conjointly incorporated into the purification circuit such that the fluid circulating in the purification circuit can also be guided through the printing head. On account thereof, contaminants that are located in the printing head can be absorbed by the fluid and discharged from the printing head. In this way, additional cleaning of the printing head and of the supply line can be performed without any notable additional effort, in order for any contamination of the fluid that is provided for the printing procedure by previously caused contaminations in these regions to be avoided.

Depending on the design embodiment of the printing head, supply lines to the individual printing head nozzles, and storage chambers, or further components of the printing head, can also be perfused and purified herein, or else the fluid can be guided up to the printing head and then be supplied to the return line without any perfusion of individual components of the printing head. It is likewise possible for the fluid to be guided past the printing head by way of a bypass line that connects the return line to the supply line.

The printing head herein can be fully incorporated into the purification circuit and be perfused by the entire fluid quantity that is recirculated in the purification circuit. It is likewise conceivable for the printing head to be connected to the purification circuit by way of a bypass line and be perfused merely by a predefined part-quantity of the fluid that is circulating in the purification circuit.

The connector installation expediently has the line portions that are required for the connection to the fluid storage container and are combined and grouped in a coupling, in a connector adapter, or in a connector plug, in order for a rapid, reliable and tight connection to the fluid storage container to be facilitated. The connector installation of the purification circuit to the fluid storage container can advantageously be designed such that the entire fluid quantity that is predefined in a fluid storage container can circulate continuously through the purification circuit. Upon demand, a plurality of fluid storage containers can then be connected to the purification circuit sequentially, or optionally simultaneously, and the content of said fluid storage containers can be purified by the printing device according to the invention, in order for a printing procedure which requires more fluid than can be kept in one fluid storage container not to be interrupted, or interrupted only very briefly, for example. It is likewise possible that only that fluid quantity that is provided for a short printing procedure is injected into the purification circuit and is purified therein so as to enable as rapid an upgrade by purification as possible of the fluid quantity that is provided for the printing procedure.

According to one particularly advantageous design embodiment of the concept of the invention, it is provided that the return line completely surrounds the supply line at least along one supply line portion. On account thereof it is caused that the fluid that is conveyed back from the printing head to the fluid storage container herein at least in portions flows about the fluid that in the supply line is conveyed to the printing head. Many organic semiconductor materials which are suitable for the production of large-area displays, for example, can be undesirably contaminated in a rapid manner by oxygen which is absorbed from the environment or ingresses to the fluid, respectively. For this purpose, many components of the printing device are designed such and produced from suitable materials such as stainless steel, for example, that any ingress of oxygen to the fluid, or a diffusion procedure of said oxygen in the fluid, respectively, is avoided and minimized as far as possible. The undesirable ingress of oxygen to the fluid which is conveyed through the supply line to the printing head can be impeded and optionally largely prevented in that the fluid that is conveyed back to the fluid storage container at least in portions completely surrounds the supply line such that oxygen from the environment that ingresses to the fluid lines can ingress substantially only to the return line and thus to the fluid that is being conveyed back again to the fluid storage container. The return line which surrounds the supply line forms an additional shield and the functional barrier for the supply line that is surrounded by the return line. The fluid that is conveyed back again through the return line, prior to being resupplied to the printing head, can be purified in a pre-emptive manner or upon demand, so as to reduce any potential contamination.

It is furthermore provided that during a printing procedure the fluid storage container is disposed in a locationally fixed manner so as to be spaced apart from the surface, and the printing head that by way of a flexible supply line and a flexible return line at least along a line displacement portion is connected to the fluid storage container for printing is displaced across the surface. A large spacing between the fluid storage container and the printing head is enabled by the potential for the fluid to be recirculated in the purification circuit and herein to be purified by way of the purification installation that is incorporated in the purification circuit, since any potential contamination within the printing device or in the purification circuit, respectively, during the printing procedure can be reduced with the aid of the purification installation. It is not necessary for the fluid storage container to be disposed directly at or on the printing head and to be displaced conjointly with the printing head across the surface during the printing procedure. The fluid storage container can be disposed in a locationally fixed manner so as to be spaced apart from the surface to be printed. The connection of the fluid storage container to the printing head is enabled by way of a flexible supply line and a flexible return line. The flexible supply line is additionally shielded by the return line that surrounds the supply line. Any contamination of the fluid that is optionally facilitated by a longer dwell time in the supply line can be reduced on demand again in that the fluid is conveyed through the return line and through the purification installation.

A cost-effective production of efficient and rapid printing devices is enabled by the arrangement of the fluid storage container so as to be spaced apart from the surface and in particular so as to be spaced apart from the printing head, and the incorporation of the latter by means of a flexible supply line and a flexible return line. The fluid storage containers which are disposed in a spaced apart and locationally fixed manner can have a significantly larger capacity than storage containers which are disposed on or at a displaceable printing head. An individual printing procedure can be carried out and completed in a significantly more rapid manner. A large number of printing procedures can be carried out with each of the large-capacity fluid storage containers before a replacement of the fluid storage container is required.

The purification installation expediently has at least one particle filter and one de-gassing installation. In many cases it can be advantageous that in the flow direction at least one first particle filter is disposed ahead of the de-gassing installation, and at least one second particle filter is disposed behind the de-gassing installation. It is likewise conceivable for a plurality of particle filters having a congruent filtration effect, or else having mesh sizes or pore diameters that in the flow direction become smaller, to be combined. In the same way, a plurality of de-gassing installations of the same type or of different types can also be combined with one another, or be employed so as to alternate with particle filters, respectively.

The contamination-measurement installation in the flow direction is expediently disposed behind the purification installation such that the purification effect caused by the purification installation can already be detected by the contamination-measurement installation.

In order to be able to also detect the contaminants optionally caused by a printing head that is perfused by the fluid and to be able to consider said contaminants in the further controlling of the method, it is provided that the confluence junction of the return line in the flow direction is disposed ahead of the contamination-measurement installation.

Depending on the measurement methods and measurement devices of the contamination-measurement installation that are used in the individual case, it can be advantageous according to the invention for a bypass-line portion in which the fluid can be conveyed through the contamination-measurement installation such that merely a predefinable fluid-specimen quantity is conveyed through the contamination-measurement installation to be disposed in the purification circuit. In many cases, the measuring period that is required for detecting a key contamination indicator is significantly greater than the time period required by the fluid to perfuse the purification installation and to thereby be purified. In order to enable as large a throughput as possible and rapid purification of the fluid that circulates in the purification circuit, it can therefore be expedient for merely a small fluid-specimen quantity to be checked and evaluated in the contamination-measurement installation, while a predominant proportion of the circulating fluid can be conveyed past the contamination-measurement installation and already be supplied to the purification installation again.

Exemplary embodiments of the concept of the invention which are schematically illustrated in the drawing will be explained in an exemplary manner in more detail hereunder. In the drawing:

FIG. 1 shows a schematic illustration of a printing device according to the invention, having a purification circuit, having a purification installation that is disposed in the purification circuit, and having a contamination-measurement installation, and having a junction with a supply line for a printing head that is disposed so as to be spaced apart from the purification circuit;

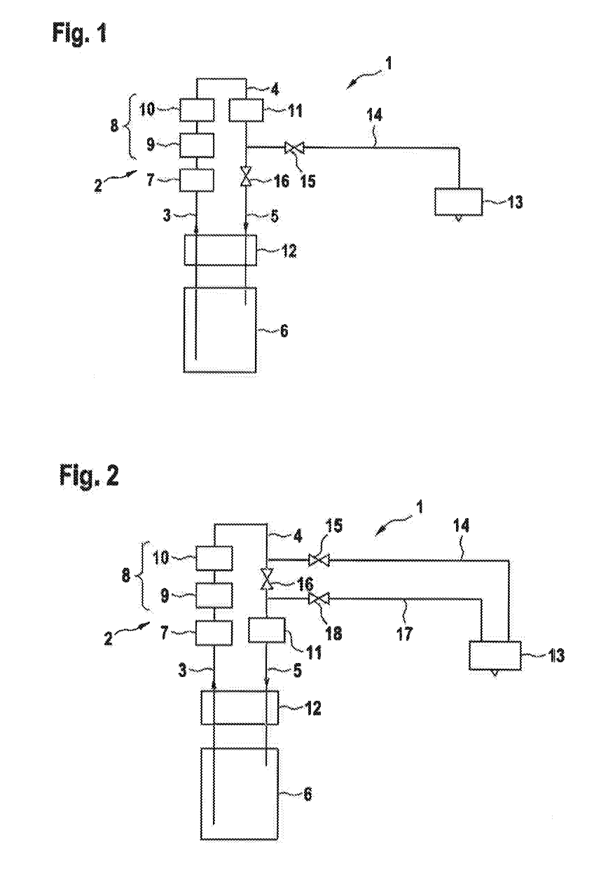

FIG. 2 shows a schematic illustration of a printing device of a deviating design, in which the printing head, in addition to a supply line, is connected to the purification circuit by way of a return line, and in which the printing head can be incorporated into the purification circuit by way of valves;

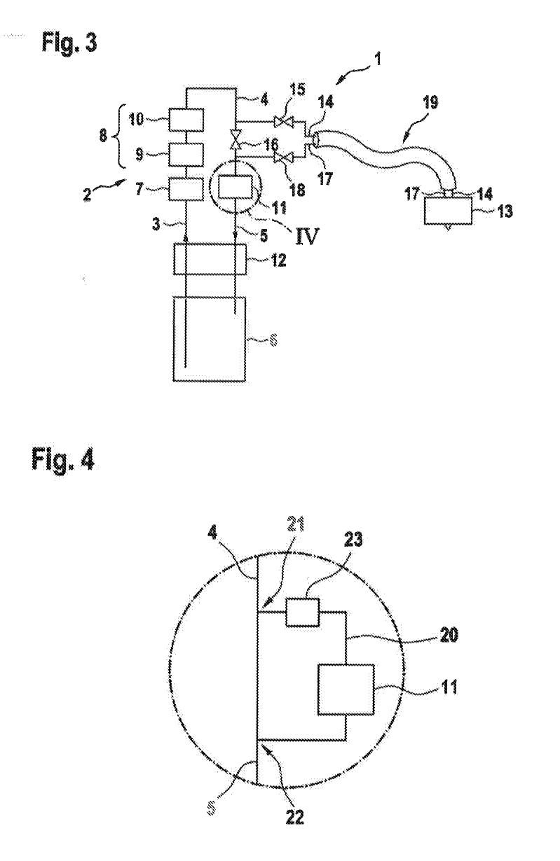

FIG. 3 shows a schematic illustration of a printing device of a yet again deviating design, in which the printing head is connected to the purification circuit by way of a flexible line displacement portion, wherein the return line surrounds the supply line and shields the latter in relation to external influences; and

FIG. 4 shows a schematic illustration of a portion of the purification circuit shown in the region IV in FIG. 3, wherein the contamination-measurement installation is incorporated into the purification circuit by way of a bypass line.

A printing device 1 that is illustrated in an exemplary manner in FIG. 1 has a purification circuit 2 which is assembled from a plurality of fluid-line portions 3, 4, 5. The fluid-line portion 3 is connected to a fluid storage container 6 that accepts 100 millilitres or 10 litres, for example, such that fluid that is located in the fluid storage container 6 by way of a pump installation 7 can be conveyed from the fluid storage container 6 to a purification installation 8. The fluid can contain organic semiconductor materials, for example OLEO materials, and optionally further additives. The purification installation 8 has at least one de-gassing installation 9 by way of which the gas content in the fluid can be reduced. A particle filter 10, for example a membrane filter having a pore diameter of 1 μm, in the flow direction is disposed behind the de-gassing installation 9.

The fluid is subsequently guided through the fluid-line portion 4 in which a contamination-measurement installation 11 is disposed. A key contamination indicator for the perfusing fluid can be established by the contamination-measurement installation 11. The fluid-line portion 4 transitions into a further fluid-line portion 5 which again opens into the fluid storage container 6, on account of which the purification circuit 2 of the printing device 1 is closed. The fluid-line portions 3 and 5 in the transition region towards the fluid storage container 6 can be combined in one common connector installation 12 which facilitates a rapid and tight connection of the fluid-line portions 3 and 5 of the purification circuit 2 to the fluid storage container 6. A dedicated connector installation for each fluid-line portion 3 and 5 can also be provided instead of one common connector installation 12. The openings of the fluid-line portions 3 and 5 that protrude into the fluid storage container form a fluid retrieval installation and a fluid refilling installation for the fluid storage container 6.

A printing head 13 of the printing device 1 is connected to the purification circuit 2 of the printing device 1 by way of a supply line 14 which branches off from the purification circuit 2 after the contamination-measurement device. By way of suitable valves 15 and 16, the supply line 14 can be either closed and the purification circuit 2 be opened, or else the supply line 14 can be opened such that fluid that circulates in the purification circuit 2 is diverted from the purification circuit 2 and supplied to the printing head 13. For example, in the case of a minor consumption during a printing procedure, merely a part-quantity of the fluid that circulates in the purification circuit 2 can be supplied to the printing head 13 herein, or else the purification circuit 2 can be shut off by the valve 16 such that the entire fluid quantity that is retrieved from the fluid storage container 6 is supplied to the printing head 13.

A deviating design embodiment of a printing device 1 according to the invention is illustrated in a merely exemplary manner in FIG. 2. In addition to the supply line 14, the printing head 13 is connected to the purification circuit 2 by way of a return line 17 and of a further valve 18, such that the printing head 13 can be conjointly incorporated into the purification circuit 2 and can be perfused by the fluid which circulates in the purification circuit 2. Depending on the design embodiment of the printing head 13, supply lines to the individual printing head nozzles, and storage chambers, or further components of the printing head 13, can also be perfused and purified, or else the fluid can be guided up to the printing head 13 and then be supplied to the return line 17 without any perfusion of individual components of the printing head 13. Cleaning of the supply line 14 and of the printing head 13 as well as of the return line 17 also takes place herein.

According to the invention, various method sequences are possible in order for the fluid that is provided for the printing procedure to be purified by way of the printing device 1 according to the invention before the commencement of a printing procedure.

The fluid can circulate in the purification circuit 2 and be continuously and increasingly purified in the purification installation 8 until a key contamination indicator that has been determined by the contamination-measurement installation 11 undershoots a first threshold value for the maximum permissible contaminant content. The purification circuit 2 can subsequently be shut off by the valve 16, and the purified fluid can be supplied to the printing head 13 by way of the supply line 14 while the printing procedure is being carried out.

The fluid can initially circulate in the purification circuit 2 without the printing head 13 being connected and being perfused by the fluid also in the case of the printing device 1 schematically illustrated in FIG. 2. A key contamination indicator is continuously established by the contamination-measurement installation 11, and the fluid is recirculated and circulated in the purification circuit 2 until a predefined third threshold value for the contaminant content is achieved or undershot, respectively. Subsequently, the printing head 13 is incorporated into the purification circuit 2 by switching valves 15, 16, and 18, and is perfused by the already purified fluid. Any potential contaminants that are located in the printing head 13 herein are absorbed by the fluid, detected in the contamination-measurement installation 11 disposed downstream in the purification circuit 2, and filtered out in subsequent perfusions of the fluid by the purification installation 8. The circulation of the fluid through the printing head 13 can continue until the key contamination indicator that is determined in the contamination-measurement installation 11 undershoots a second threshold value.

The second threshold value can correspond to the first threshold value that has been mentioned and used in the exemplary embodiment that has been previously explained. A threshold value deviating therefrom can also be predefined, in order, for example, for a less stringent contaminant content after cleaning of the printing head 13 to be predefined by the contamination-measurement installation 11, since any subsequent contamination of the fluid by the already cleaned printing head 13 can be precluded.

It is likewise possible for the printing head 13 to be conjointly incorporated and perfused by the fluid and herein purified already as from the first circulation of the fluid through the purification circuit 2.

It can be achieved in all cases that the contaminations of the actual fluid quantity used for the printing procedure are checked and reduced to below a predefined threshold value before the printing procedure commences. A dedicated preceding check measurement is no longer required.

In the case of the exemplary embodiment illustrated in FIG. 3 the supply line 14 and the return line 17 are configured so as to be flexible along a line displacement portion 19, such that the printing head 13 is connected to the purification circuit 2 so as to be displaceable relative to the purification circuit 2. Moreover, in the line displacement portion 19, the return line 17 which is configured so as to be hollow-cylindrical surrounds the supply line 14 that is disposed so as to be centric in said return line 17, the latter additionally shielding the supply line 14 in relation to environmental influences and contaminations that are caused on account thereof.

In the case of the exemplary embodiment illustrated merely in fragments in FIG. 4, the contamination-measurement installation 11 is disposed in a bypass-line portion 20 which by way of a junction 21 branches off from the fluid-line portion 4 and by way of a further junction 22 returns back into the fluid-line portion 5. Only a small fluid-specimen quantity which merely represents a minor proportion of the fluid that circulates in the purification circuit 2 in each case perfuses the contamination-measurement installation 11. The respective proportion of the fluid quantity that perfuses the bypass-line portion 20 and the fluid-line portion 4, routed in parallel with the former, can be detected or checked, respectively, by way of a throughflow-measurement installation 23.

Independently of the respective design embodiment of the printing devices 1, or of the exemplary embodiments shown merely in an exemplary manner, it is possible for a flexible fluid storage container which can be a bag or a flexible plastics container, for example, to be used instead of a rigid fluid storage container 6 which can be a bottle or a metallic container, for example.

1. Method for operating a printing device (1), wherein a fluid that is provided for a printing procedure is supplied from a fluid storage container (6) by way of a supply line (14) to a printing head (13) so as to be able to be applied by the printing head (13) onto a surface, characterized in that the fluid in a purification circuit (2) is conveyed through a purification installation (8), and by way of a contamination-measurement installation (11) a key contamination indicator of a fluid-specimen quantity in the purification circuit (2) is determined, and in that a printing procedure by way of which the fluid is dispensed from the printing head (13) commences only once the key contamination indicator has undershot a first threshold value.

2. Method according to claim 1, characterized in that the fluid-specimen quantity that is provided for determining the key contamination indicator is diverted from the purification circuit (2), is supplied to the contamination-measurement installation (11), and upon determining the key contamination indicator is again returned into the purification circuit (2).

3. Method according to claim 1, characterized in that the printing head (13) has a return line (17) into the purification circuit (2), and in that a printing head cleaning fluid quantity that is conveyed into the printing head (13) is again retrieved from the printing head (13) and is returned into the purification circuit (2).

4. Method according to claim 3, characterized in that a key contamination indicator of that printing head cleaning fluid quantity that has been returned from the printing head (13) is determined by the contamination-measurement installation (11), and in that the printing procedure by way of the printing head (13) commences only once the key contamination indicator undershoots a second threshold value.

5. Method according to claim 3, characterized in that the fluid is supplied to the printing head (13) only once a key contamination indicator that is determined in the fluid-purification step of the fluid that is conveyed in the purification circuit (2) undershoots a third threshold value.

6. Method according to claim 1, characterized in that the fluid in the fluid-purification step is conveyed through at least one particle filter (10) and through at least one de-gassing installation (9).

7. Method according to claim 1, characterized in that the key contamination indicator is composed of one of the plurality of key particle-content indicators and of one or a plurality of key gas-content indicators, each being detected by the contamination-measurement installation (11).

8. Printing device (1) having a printing head (13) and having a connector installation (12) for a fluid storage container (6), said connector installation (12) being connected to the printing head (13) by way of a supply line (14) such that the fluid from the fluid storage container (6) can be supplied to the printing head (13) and be applied by the printing head (13) onto a surface, characterized in that the connector installation (12) has a fluid retrieval installation and a fluid refilling installation for the fluid storage container (6), in that the printing device (1) has a purification circuit (2) that is formed from fluid-line portions (3, 4, 5) and has a purification installation (8) and has a contamination-measurement installation (11) in which the fluid that by way of the fluid retrieval installation has been retrieved from the fluid storage container (6) can be purified, a key contamination indicator of a fluid-specimen quantity in the purification circuit (6) can be determined, and the fluid by way of the fluid refilling installation can again be supplied to the fluid storage container (6), and in that the supply line (14) branches off from the purification circuit (2) and connects the purification circuit (2) to the printing head (13) such that the fluid that perfuses the purification circuit (2) can be supplied to the printing head (13).

9. Printing device (1) according to claim 8, characterized in that a return line (17) connects the printing head (13) to the purification circuit (2) such that the fluid that is supplied to the printing head (13) can perfuse the printing head (13) and again be supplied to the purification circuit (2).

10. Printing device (1) according to claim 9, characterized in that the return line (17) on the printing head (13) is connected to the supply line (14) by way of a bypass line.

11. Printing device (1) according to claim 9, characterized in that the return line (17) completely surrounds the supply line (14) at least along one supply line portion.

12. Printing device (1) according to claim 8, characterized in that the printing head (13) is displaceable above an area to be printed, and in that the supply line (14) and the return line (17) are flexible at least along a line displacement portion (19).

13. Printing device (1) according to claim 8, characterized in that the purification installation (8) has at least one de-gassing installation (9) and at least one particle filter (10).

14. Printing device (1) according to claim 13, characterized in that in the flow direction at least one first particle filter (10) is disposed ahead of the de-gassing installation (9), and at least one second particle filter (10) is disposed behind the de-gassing installation (9).

15. Printing device (1) according to claim 8, characterized in that the contamination-measurement installation (11) in the flow direction is disposed behind the purification installation (8).

16. Printing device (1) according to claim 9, characterized in that the return line (17) in the flow direction opens into the purification circuit ahead of the contamination-measurement installation (11).

17. Printing device (1) according to claim 8, characterized in that a bypass-line portion (20) through which the fluid can be conveyed through the contamination-measurement installation (11) such that merely a predefinable fluid-specimen quantity is conveyed through the contamination-measurement installation (11) is disposed in the purification circuit (1).
